(19) United States
(12) Patent Application Publication
(10) Pub. No.: US 2021/0403716 A1
(43) Pub. Date: Dec. 30, 2021

(54) THERMALLY CONDUCTIVE COMPOSITION CONTAINING MGO FILLER AND METHODS AND DEVICES IN WHICH SAID COMPOSITION IS USED

(71) Applicants: Dow Global Technologies LLC, Midland, MI (US); Dow Silicones Corporation, Midland, MI (US)

(72) Inventors: Xiaolian Hu, Shanghai (CN); Jiguang Zhang, Shanghai (CN); Yan Zheng, Shanghai (CN); Hongyu Chen, Shanghai (CN); Chen Chen, Shanghai (CN); Dorab Bhagwagar, Saginaw, MI (US); Darren Hansen, Auburn, MI (US)

(21) Appl. No.: 17/281,484

(22) PCT Filed: Dec. 29, 2018
(86) PCT No.: PCT/CN2018/125408

§ 371 Date: Mar. 30, 2021

(51) Int. Cl. C08L 83/00; C08K 3/22; C08K 5/3417

(52) U.S. Cl. CPC C08L 83/00; C08K 3/22; C08K 5/3417; C08K 2201/005; C08K 2003/2227; C08K 2003/2296; C08K 2003/222

(57) ABSTRACT

A highly thermally conductive composition is provided, such composition comprising: (A) An organopolysiloxane composition; (B) a filler treating agent; (C) a thermal stabilizer; and (D) thermally conductive filler mixture, comprising: (D-1) a small-particulate thermally conductive filler having a mean size of up to 1 μm, (D-2) middle-sized filler having a mean size of from 1 to 10 μm, (D-3) large filler having a mean size of larger than 30 μm and comprising at least magnesium oxide.

### FIELD OF THE INVENTION

A highly thermally conductive silicone composition, methods for preparation and use of the same, and devices containing the same are disclosed. The silicone composition may be used as a thermal interface material and as part of heat dissipating materials in electronic devices.

### BACKGROUND

As the telecommunications industry is going through a generational shift to 5G networks, highly integrated electrical devices with smaller size will bring doubled power consumption (power unit from 600 W to 1200 W), with higher heat generation that would impair performance if unattended. Thus, a higher-efficiency thermal management system is urgently demanded.

Magnesium oxide (MgO) is known to be heat conductive, and various heat conductive materials that contain MgO are known. JP6075261 describes a thermally conductive silicone composition with a thermal conductivity of 1.5 W/m·K, with MgO filler having a particle size of 60 to 80 micrometer (μm) that has been surface-treated to lower the viscosity of the composition. US20090143522A1 describes thermally conductive compositions with a combination of a large-sized filler of MgO with size of up to 50 μm and a small-size filler, which provided thermal conductivity of up to 6 W/m·K. U.S. Pat. No. 5,569,684 disclosed a method of surface treatment of MgO filler, where the filler volume was up to 70% of the total composition volume, but the thermal conductivity was not particularly high. CN105542476 describes the use of MgO fillers with two size distribution peaks at 10 μm and 5 μm, along with aluminum nitride (AlN) fillers, but the thermal conductivity achieved is lower than 2 W/m·K. Thus, none of the closely related prior technology has so far achieved the thermal conductivity level over 6 W/m·K that the industry demands now.

### SUMMARY OF THE INVENTION

A silicone composition with thermal conductivity of greater than 6 W/m·K is provided, wherein the thermally conductive composition comprises organopolysiloxanes and MgO fillers. The filler may comprise only of MgO or MgO in combination with other materials such as AlN, aluminum oxide (Al₂O₃) or boron nitride (BN). The present invention also is a method comprising interposing the inventive thermally conductive composition along a thermal path between a heat source and a heat dissipater. Such heat source may comprise an (opto)electronic component, central processing units, current converters, batteries such as lithium ion batteries, and any other parts and units that produce heat upon operation mainly powered by or involving electricity. Another aspect of the present invention is a device comprising: a) a heat source, b) the inventive thermally conductive composition, and c) a heat dissipater, where the composition is positioned between the heat source and the heat dissipater along a thermal path extending from a surface of the heat source to a surface of the heat dissipater. The heat source may comprise an electronic component. The device can be telecommunication and/or computing equipment such as servers, personal computers, tablets and handheld devices, electronic modules, in particular power electronics modules, electronic control units in automobiles, and electric vehicle battery packs.

### DETAILED DESCRIPTION OF THE INVENTION

All amounts, ratios, and percentages are by weight unless otherwise indicated. Weight percent is shown as wt %. Volume percent, when appropriate, is shown as vol %. The following terms are used herein with the intention to give them the meanings as described below.

The articles “a”, “an”, and “the” each refer to one or more. “Combination” means two or more items put together by any method. “cSt” means centiStokes. “DP” means degree of polymerization, i.e. the number of monomers found in a polymer molecule. For linear polysiloxane, DP is determined by ²⁹Si—NMR, from the ratio of the number of terminal siloxy unit (R³SiO—) and the number of the chain-forming divalent siloxy unit (—R²SiO—). In resins, the DP is accurately calculated from the structure of the starting materials. For other polysiloxanes, DP is calculated from the molecular size of the polymer determined by gel permeation chromatography using polystyrene as the standard samples and the known side chains; a siloxy unit with methyl groups attached is approximately 100 g/mole. “May” indicates a choice. “mPa·s” means millipascal second. “Surface-treated” means that all, or a portion of, reactive groups on the surface of a particle have been rendered unreactive by any convenient chemical or unreactive means. The abbreviation “W” means Watts, “W/m·K” means Watts per meter Kelvin, and “μm” means micrometers. As used herein, “alkyl” group means aliphatically saturated group, that, unless otherwise specified, consist of carbon and hydrogen, non-limiting examples of which are methyl, ethyl, propyl, butyl, pentyl, hexyl, octyl, decyl, undecyl, dodecyl, octadecyl, and eicosyl, and their isomers when there are more than 3 carbon atoms. “Cycloalkyl” means alkyl where some or all carbon atoms participate in forming a circular structure with no aliphatic unsaturation within the circle, exemplified by cyclopentyl and cyclohexyl. As used herein, “alkenyl” group means a group having an aliphatically unsaturated bond and consisting of carbon and hydrogen, non-limiting examples of which are vinyl, allyl, butenyl, pentenyl, hexenyl, heptenyl, decenyl, undecenyl, dodecenyl, tridecenyl, tetradecenyl, pentadecenyl, hexadecenyl, heptadecenyl octadecenyl, nonadecenyl, eicosenyl and their isomers where there are more than 3 carbon atoms. As used herein, “aryl” group means group derived from monocylic and polycyclic aromatic hydrocarbons, by removal of a hydrogen atom from a ring carbon atom, the non-limiting examples of which are phenyl, tolyl, xylyl, naphthyl, benzyl, and phenylethyl. As used herein, “Me” indicates methyl group (CH₃—), and “Vi” indicates vinyl group (—CH═CH₂). The term “ppm” refers to weight parts per million.

Unless otherwise indicated, viscosity was measured at 25° C. by a method based on ASTM D-445, IP 71, using a viscosity glass capillary (CTM0004 A), where the kinematic viscosity of liquids was determined by measuring the time required for a fixed volume of sample to pass through a calibrated glass capillary using gravity flow. Unless otherwise indicated, particle size was determined by laser diffraction particle size analyzers (for example CILAS920 Particle Size Analyzer or Beckman Coulter LS 13 320 SW) according to the operation software and shown as number average particle size. For particles smaller than those having 1 μm, scanning electron microscopy is used to visualize and measure particle size. For convenience, the average particle size may be estimated based on measuring the surface area according to 8-11 ASTM D4315 or by using sieves of various mesh sizes and calculating the average from the cumulative weight of each size fractions. Test methods refer to the most recent test method as of the priority date of this document when a date is not indicated with the test method number. References to test methods contain both a reference to the testing society and the test method number. The following test method abbreviations and identifiers apply herein: ASTM refers to ASTM International; EN refers to European Norm; DIN refers to Deutsches Institut für Normung; and ISO refers to International Organization for Standards.

### Thermally Conductive Composition.

The thermally conductive composition of the present invention comprises: (A) An organopolysiloxane composition; (B) a filler treating agent; (C) a thermal stabilizer; and (D) thermally conductive filler, which comprises at least three groups with distinct average particle size peaks, small, middle and large: (D-1) a small-particulate thermally conductive filler having a number average size of up to 1 μm; (D-2) a middle-sized thermally conductive filler having a number average size of from 1 to 20 μm; and (D-3) large size fillers having a number average particle size of 20 to 200 μm that may comprise solely magnesium oxide (MgO) or may include particles comprising other materials such as aluminum nitride (AlN), aluminum oxide (Al₂O₃) or boron nitride (BN). The composition comprises thermally conductive fillers in the amount that would result in at least 70 vol % of the total composition, and may further comprise other thermally conductive particles. The total amount of MgO filler particles, regardless of the particle size, is no more than 65 vol % of the composition as a whole.

(A) Base polymer. Component (A) of the thermally conductive composition is an organopolysiloxane composition. An example of component (A) comprises an organopolysiloxane having a general formula (I)

R¹₃SiO—(R¹R²SiO)ₐ(R¹₂SiO)_{b}—R³SiR¹₃ (I)

wherein each R¹ is independently a monovalent organic group free of aliphatic unsaturation, i.e., a straight or branched alkyl group, preferably consisting of 1, 2, 3, or up to 6 carbon atoms. R¹ may be a methyl group. Each R² is an aryl group. R² may be a phenyl group. Each R³ is selected from an oxygen atom or a divalent hydrocarbon group. Whether R³ is an oxygen atom or a divalent hydrocarbon group depends on the method used to prepare the organopolysiloxane of formula (I). The divalent hydrocarbon group may consist of 1 or more, 2 or more, 3 or more, 4 or more, 5 or more, and at the same time generally consists of up to 6, up to 10, or up to 12 carbon atoms. Preferably, R³ is an oxygen atom. Subscript “a” may be 0, or has an average value of at least 1, and subscript “b” has an average value of at least 1. General formula (I) shows an average molecular formula of the collective molecules of component (A). Subscript “a” and subscript “b” may have average values such that the sum (a+b) is sufficient to provide the organopolysiloxane of formula (I) with a viscosity ranging from 10 or more, 20 or more, 40 or more, and at the same time 100 or less, 200 or less, 300 or less, or up to 400 mPa·s, but the range of from 20 to 400 mPa·s is desirable for good processability. An exemplary viscosity is 100 mPa·s. The sum (a+b) is a positive number in a range of 20 or more, 50 or more, and 80 or more, and at the same time up to 100, 120, 150, or 200. The sum (a+b) may preferably be in the range from 20 to 150. The molar ratio of a/b may range up to 4.2, from 0, from 0.2, or alternatively from 0.38.

The organopolysiloxane of formula (I) may be trimethylsiloxy-end-capped poly(dimethylsiloxane/methylphenylsiloxane) copolymer, available as DOWSIL™ 510 Fluid or 550 Fluid from Dow Silicones Corporation of Midland, Mich., USA. DOWSIL is a trademark of The Dow Chemical Company.

When subscript “a” is zero, the organopolysiloxane of formula (I) may be trimethylsiloxy-terminated polydimethylsiloxane, commercially available from various sources.

The organopolysiloxanes of formula (I) may be prepared by well-known methods fully described in literature, such as hydrolysis and condensation of the corresponding organohalosilanes or equilibration of cyclic diorganopolysiloxanes. For example, organopolysiloxanes may be prepared by ring opening polymerization of cyclic diorganopolysiloxanes using a lithium catalyst to yield organopolysiloxanes having silicon-bonded hydroxyl groups. Thereafter, the organopolysiloxanes having silicon-bonded hydroxyl groups may be reacted with alkoxysilanes to prepare component (A). Alternatively, organopolysiloxanes suitable for use as component (A) may be prepared by methods such as those disclosed, for example, in U.S. Pat. No. 4,962,174.

The organopolysiloxane of component (A) may be branched, having small amounts of monoalkylsiloxane units (R¹SiO_{3/2}) at the branching points, so long as component (A) has a viscosity ranging from 10 to 400 mPa·s or more specifically, from 10 or more, 20 or more, 40 or more, and at the same time 100 or less, 200 or less, 300 or less, or up to 400 mPa·s.

Component (A) can be one single organopolysiloxane or a combination comprising two or more organopolysiloxanes that differ in at least one of the following properties: structure, viscosity, average molecular weight, siloxane units, and sequence.

Component (A) may be a curable mixture comprising one or more siloxane components that are capable of reacting with each other to form cross-links. Curable component (A) may remain uncured, cure during the preparation of the thermally conductive silicone composition, cure after the thermally conductive silicone composition is placed proximally to a heat bearing item from which heat is conducted through the thermally conductive silicone composition, or be cured by hydrosilylation prior to the addition to the thermally conductive silicone composition. Component (A) may be cured partially or fully to give a cured composition having a viscosity/hardness of Shore 00 (5 to 85), and may have soft putty texture, the hardness of which cannot be measured. The curing mechanism of the curable mixture is not particularly limited, including addition cure, condensation cure, or UV radical cure.

The total amount of component (A) depends on various factors including the organopolysiloxanes selected for component (A) and the thermally conductive filler selected for component (B). However, the total amount of component (A) (i.e., all the organopolysiloxanes combined) may range from 2 vol % to 35 vol %, alternatively 10 vol % to 15 vol %, and alternatively 10 vol % to 35 vol % of total volume of all components in the thermally conductive composition.

(B) Filler treating agent. Component (B) of the thermally conductive composition comprises a reactive silane and/or a reactive silicone for surface-treatment of fillers. Treating agents and treating methods are known in the art, see for example, U.S. Pat. No. 6,169,142 (col. 4, line 42 to col. 5, line 2).

The amount of component (B) may vary depending on various factors including the type and amounts of fillers selected for component (D) and whether the filler is treated with component (B) in situ or before being combined with other components of the thermally conductive composition. Regardless, the thermally conductive composition may comprise an amount ranging from 0.1 wt % to 2 wt %, and any value in between, of component (B).

Component (B) may comprise an alkoxysilane having the formula:

R⁵ᵣSi(OR⁶)₍₄₋ᵣ₎, (II)

where subscript r is 1, 2, or 3; preferably r is 3.

Each R⁵ is independently a monovalent organic group, such as a monovalent hydrocarbon group of 1 or more, preferably 6 or more and at the same time 50 or fewer, preferably 18 or fewer carbon atoms. R⁵ can be saturated or unsaturated, branched or unbranched, and unsubstituted. R⁵ is exemplified by alkyl groups and aryl groups, and in particular methyl, ethyl, hexyl, octyl, decyl, dodecyl, octadecyl, phenyl or phenylethyl group, in combination with any of the R⁶ described below. Preferably, R⁵ is a decyl group.

Each R⁶ may be an alkyl group of 1 to 4 carbon atoms, alternatively 1 to 2 carbon atoms. Alkoxysilanes for component (B) are exemplified by hexyltrimethoxysilane, octyltriethoxysilane, decyltrimethoxysilane, dodecyltrimethoxysilane, tetradecyltrimethoxysilane, phenyl-trimethoxysilane, phenylethyltrimethoxysilane, octadecyltrimethoxysilane, octadecyl-triethoxysilane, and a combination thereof. Component (B) may be n-decyltrimethoxysilane.

Component (B) may also be alkoxy-functional oligosiloxanes. Alkoxy-functional oligosiloxanes and methods for their preparation are known in the art, see for example, EP1403326B1 and U.S. Pat. No. 6,844,393. Suitable alkoxy-functional oligosiloxanes include those of the formula

[R⁷ₛR⁸₍₃₋ₛ₎SiO(R⁷ₜR⁸₍₂₋ₜ₎SiO)ₘ(R⁸₂SiO)ₙ(R⁸ᵤ(OR⁹)₍₂₋ᵤ₎SiO)ₒ]ᵥSiR⁸_{[4-(v+x)]}(OR⁹)ₓ (III)

In this formula, each R⁷ may be independently selected from alkenyl groups, including alkenyl groups attached to cyclic alkyl or aryl groups (e.g. vinylcyclohexyl, vinylphenyl, vinylbenzyl, vinylphenetyl), having 2 or more and at the same time 6 or fewer, 8 or fewer, 10 or fewer, 12 or fewer carbon atoms; R⁷ preferably is vinyl, allyl, or hexenyl. Each R⁸ may be independently selected from linear or branched alkyl, cycloalkyl, aryl, and aralkyl (i.e. aryl-substituted alkyl, e.g. benzyl or phenethyl) groups having at least 1 carbon atom and up to 20 carbon atoms; R⁸ may be halogenated. Preferably, R⁸ is methyl or ethyl. Each R⁹ may be same or different from each other, and may be alkyl, alkoxyalkyl, alkenyl, or acyl, each preferably having 1, 2, 3, 4, 6, or up to 10 carbon atoms and may be straight chain, branched, or cyclic. Preferred alkyl is methyl, ethyl, or propyl; preferred alkoxyalkyl is methoxyethyl, ethoxyethyl, or methoxyprogyl; preferred alkenyl is vinyl, allyl, or isopropenyl; acyl may be acetyl. All subscripts are integers and each selected from the following range or choices; subscript s is 0 to 3; subscript t is 1 or 2; subscript u is 0, 1, or 2; and subscript v is 1, 2, or 3; subscript x is 0 to 3; provided that v and x are selected so that the sum (v+x) is 1 to 4. Subscripts m, n, and o are each independently an integer of 0 to 100, provided that when s is 0, m is 1 or more, when x is 0, u is 0 or 1 and at the same time o is 1 or more, and the sum (m+n+o) is 1 or more and no more than 200. Preferably, m, n, and o are each independently 1 or more, 5 or more, or 10 or more, and at the same time 10 or less, 25 or less, 50 or less, or 75 or less, up to 100. Preferred oligosiloxane may be trialkoxysiloxy-terminated dimethylpolysiloxane such as (MeO)₃Si(OSiMe₂)₁₁₀OSiMe₃ and may also contain an alkenyl group at the terminal, exemplified by (MeO)₃Si(OSiMe₂)₂₅OSiMe₂Vi. Component (B) may be mono dimethylvinylsiloxy- and mono trimethoxysiloxy-terminated dimethyl siloxane.

Metal fillers can also be treated with alkylthiols such as octadecyl mercaptan and others, and fatty acids such as oleic acid, stearic acid, titanates, titanate coupling agents, zirconate coupling agents, and a combination thereof.

(C) Thermal Stabilizer. The thermally conductive composition comprises a (C) thermal stabilizer. Indanthrene blue, terphenyl, phthalocyanines or metal phthalocyanines are examples of suitable thermal stabilizers that impart a resistance to degradation in the presence of heat and ionizing radiation to specified types of silicone elastomers. Polynuclear benzenoid compounds such as copper phthalocyanine and ingoid dyes are also suitable thermal stabilizers known to improve the thermal stability of silicone elastomers cured using organic peroxides. In particular, phthalocyanine with or without a metal atom conjugated, are desirably included in the thermally conductive composition.

Suitable phthalocyanine compounds are represented by formula (IV) and metal-chelated states are represented by formula (V).

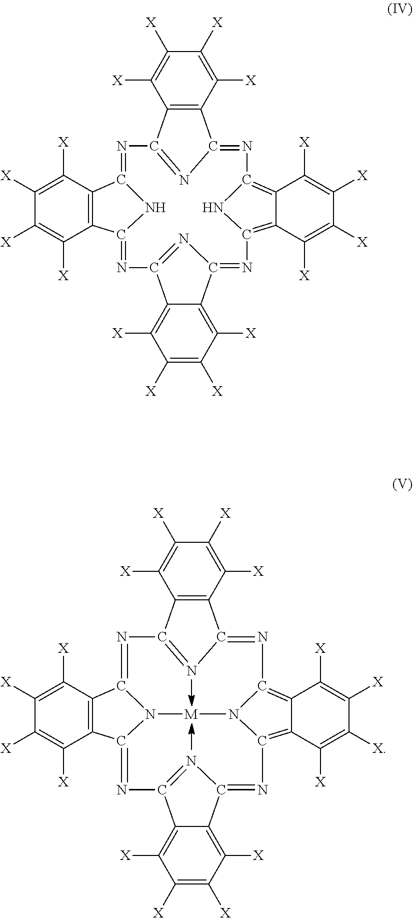

In formula (IV) and (V), X each independently represents a hydrogen or halogen atom. Suitable halogen atoms are chlorine, bromine, and iodine. In formula (V), M is a metal atom selected from copper, nickel, cobalt, iron, chromium, zinc, platinum, and vanadium. When M is copper, all X are hydrogens. Preferably, the phthalocyanine compound is 29H, 31H-phthalocyanine, and a preferred metal-chelated phthalocyanine compound is 29H, 31H-phthalocyaninato (2-)-N29, N30, N31, N32 copper. Phthalocyanine compounds are available commercially, such as Stan-tone™ 40SP03 or 50SP01 from PolyOne Corporation, Avon Lake, Ohio, USA.

Component (C) is present in to the thermally conductive organopolysiloxane composition in an amount such that in terms of weight units the phthalocyanine compound is desirably 0.01 wt % or more, 0.05 wt % or more, even 0.07 wt % or more while at the same time is desirably 5.0 wt % or less, 0.2 wt % or less or even 0.1 wt % or less of the composition as a whole.

(D) Thermally conductive filler. The thermally conductive composition of the present invention is characterized by the three different groups of filler particles that work synergistically to provide a high thermal conductivity. Each of the three groups is defined by the size distribution and the type of material that the filler particles comprise. The particles may be spherical, nearly spherical, semi-spherical, or irregular in shape so long as the aspect ratio is no more than 3:1 as determined by electron micrograph. In some particles, the aspect ratio is in the range of 2:1 to 30:1.

Group (D-1) comprises small-particulate thermally conductive filler having a number average size of up to 1 μm. The number average size may be as small as 0.1 μm. Particles in group (D-1) may comprise one or any combination of more than one particle selected from a group consisting of zinc oxide, aluminum oxide, and aluminum nitride.

Group (D-2) comprises particles having a number average size of from 1 to 20 μm. The number average size in μm may 2 or more, 3 or more, 5 or more, 7 or more, while at the same time can be 17 or less, 15 or less, 12 or less, 10 or less, 7 or less, 6 or less, or, when containing small size particles 1 or larger, may be 5 or less and even 4 or less. Middle sized particles may be spherical or irregular in shape. The preferred material is aluminum nitride. Fillers may be metallic fillers with surface layers of aluminum nitride.

Group (D-3) comprises particles having a number average size of from 20 to 200 μm. The number average size in μm may be 30 or more, 40 or more, 50 or more, 70 or more, 100 or more, 120 or more, 150 or more, and the same time may be 150 or less, 100 or less, 70 or less, 50 or less or even 40 or less. The preferred material is magnesium oxide.

Each of the group (D-1), (D-2) and (D-3) may contain more than one uniform group of fillers. For example, each group may comprise particles having two or more peaks in a size distribution plot. (D-1) may comprise particles with different compositions such as containing both zinc oxide and aluminum oxide. The size distribution within each of the group (D-1), (D-2), and (D-3) may be have a standard deviation value of 1, or may be less than 1, indicating a narrower distribution around the center value. The upper and lower distribution curve around the center value is generally symmetrical, but may have a longer tail on one side compared to the other.

The thermally conductive composition may further comprise additional thermally conductive particles (“additional fillers”) made from materials other than zinc oxide, aluminum oxide, aluminum nitride or magnesium oxide. Additional fillers may be selected from the group consisting of aluminum trihydrate, barium titanate, beryllium oxide, carbon fibers, diamond, graphite, magnesium hydroxide, metal particulate, onyx, silicon carbide, tungsten carbide, and a combination thereof. Additional fillers may be metallic fillers. Suitable metallic fillers are exemplified by particles of metals selected from aluminum, copper, gold, nickel, silver, and combinations thereof, and alternatively aluminum. Suitable metallic fillers are further exemplified by particles of the metals listed above having layers on their surfaces selected from aluminum oxide, copper oxide, nickel oxide, silver oxide, and combinations thereof.

Additional fillers may comprise bismuth (Bi), gallium (Ga), indium (In), tin (Sn), or an alloy thereof. The alloys may comprise gold (Au), silver (Ag), cadmium (Cd), copper (Cu), lead (Pb), tin (Sn), or a combination thereof. Examples of alloys include Ga, In—Bi—Sn alloys, Sn—In—Zn alloys, Sn—In—Ag alloys, Sn—Ag—Bi alloys, Sn—Bi—Cu—Ag alloys, Sn—Ag—Cu—Sb alloys, Sn—Ag—Cu alloys, Sn—Ag alloys, Sn—Ag—Cu—Zn alloys, and combinations thereof. The filler may be a eutectic alloy, a non-eutectic alloy, or a pure metal, and may be meltable. A meltable filler may have a melting point ranging from 50° C. to 250° C., alternatively 150° C. to 225° C.

These fillers are commercially available. For example, MgO particles are available from Denka, Japan, and aluminum oxide of differing particle sizes are commercially available as DAW series of products from Denka, Japan, and from Showa Denko or Sumitomo Chemical Co., both of Japan. ZRI is also a commercial source of aluminum oxide. Zinc oxides are commercially available from, e.g., American Zinc Recycling Corp., Pittsburgh, Pa., U.S.A. (under trademark KADOX®) or from Zochem LLC, Dickson, Tenn., U.S.A. MN particles are available from Toyo Aluminum or Maruwa of Japan. Metal fillers are available from, e.g., Indium Corp., Utica, N.Y., U.S.A.; Arconium Specialty Alloys Company, Providence, R.I., U.S.A.; and AIM Metals & Alloys LP, Montreal, Canada. Aluminum fillers are commercially available, e.g., from Toyal America, Inc. of Naperville, Ill., U.S.A. and Valimet Inc., of Stockton, Calif., U.S.A. Silver filler is commercially available from Metalor Technologies SA, Switzerland.

Relative to the total volume of the thermally conductive composition, the preferred volume ratio of thermally conductive fillers in total is at least 70 vol %, preferably 80, 85, 90, 95, or 97 vol %, but no more than 98 vol %. Within the thermally conductive filler, the amount of MgO is at least 5 vol %, and may be 15 vol % or more, 25 vol % or more, 40 vol % or more, and at the same time no more than 50 vol %, 55 vol %, or 65 vol % relative to the total amount of thermally conductive fillers. The preferred volume ratio of MgO in a silicone composition is in range of 5 to 65 vol %, and may be 10 vol % or more, 20 vol % or more, 30 vol % or more, 40 vol % or more, and at the same time no more than 50 vol %, 60 vol %, or 64 vol % relative to the total amount of the silicone composition. The shape of the thermally conductive filler particles is not specifically restricted, however, rounded particles may prevent viscosity increase to an undesirable level upon high loading of the thermally conductive filler in the composition.

### Additional Ingredients

When component (A) is a curable composition, the thermally conductive composition may further comprise (E) curing catalyst and/or (F) curing inhibitor. The thermally conductive composition may further comprise one or more additional ingredient selected from (G) a spacer, (H) a stabilizer, (I) a pigment, (J) a vehicle, (K) a wetting agent, and (L) a flame retardant.

(E) Curing catalyst. Component (E) is a catalyst that accelerates a hydrosilylation reaction. Suitable hydrosilylation catalysts are well-known in the art and commercially available. Component (E) may comprise a platinum group metal selected from platinum, rhodium, ruthenium, palladium, osmium or iridium metal or organometallic compound, complexes, or ligands thereof, or a combination thereof.

Component (E) is used in an amount such that in terms of weight units the content of platinum group metal is generally 0.01 ppm or more, 0.1 ppm or more, one ppm or more, 2 ppm or more, or even five ppm or more while at the same time is generally 1,000 ppm or less, 500 ppm or less, 200 ppm or less or even 150 ppm or less, relative to the total weight of components (A) and (B).

(F) Curing inhibitor. Component (F) is an inhibitor to prevent premature curing of the curable composition and to adjust speed of curing, to improve handling of the composition under industrial conditions. Various inhibitors are known in the art. The amount of such inhibitors in a curable thermally conductive silicone composition differs based on the curing mechanism, but may be within the range of 0.0001 to 5 wt % of component (A).

(G) Spacer. Component (G) is a spacer, i.e. particles that are not thermally conductive. Spacer may comprise organic particles, inorganic particles, or a combination thereof. Spacers may have a particle size ranging from at least 50 μm, at least 100 μm or at least 150 μm, and at the same time, up to 125 μm or up to 250 μm. Spacers may comprise monodisperse beads such as glass or polymer (e.g., polystyrene) beads. The amount of spacer depends on various factors including the distribution of particles, pressure to be applied during placement, and temperature during placement. Component (G) may be added to control bondline thickness of the cured product of the curable composition. The thermally conductive silicone composition may contain at least 0.05 wt %, alternatively at least 0.1 wt %, and at the same time up to 1 wt %, alternatively to 2 wt %, up to 5 wt % or up to 15 wt % of spacer added.

(H) Antioxidant Stabilizer. Component (H) antioxidant stabilizer may be added to the thermally conductive silicone composition in an amount ranging from 0.001 wt % to 1 wt %. Suitable stabilizers may be antioxidants, which are known in the art and commercially available. Suitable antioxidants include phenolic antioxidants and combinations of phenolic antioxidants with stabilizers. Phenolic antioxidants include fully sterically hindered phenols and partially hindered phenols. Stabilizers include organophosphorous derivatives such as trivalent organophosphorous compound, phosphites, phosphonates, and a combination thereof; thiosynergists such as organosulfur compounds including sulfides, dialkyldithiocarbamate, dithiodipropionates, and a combination thereof; and sterically hindered amines such as tetramethyl-piperidine derivatives.

Commercially available stabilizers include vitamin E and IRGANOX® 1010, which comprises pentaerythritol tetrakis(3-(3,5-di-t-butyl-4-hydroxyphenyl)propionate), from BASF Corporation, Charlotte, N.C., USA.

(I) Pigment. Examples of suitable component (I), pigments, include carbon black, readily available commercially. The amount of pigment depends on various factors including the pigment selected and tint of the color desired, however, when present the amount of pigment may range from 0.0001 wt % to 1 wt % based on the combined weights of all ingredients in the thermally conductive silicone composition. The thermal stabilizer component (C) may also provide color (often blue or green), but is specifically excluded from component (I).

(J) Vehicle. Additional component (J) is a vehicle such as a solvent or diluent. Component (J) may be added during preparation of the thermally conductive silicone composition, for example, to aid mixing and delivery. All or a portion of component (J) may additionally be removed after the thermally conductive silicone composition is prepared. Component (J) may be an organic solvent. Alternatively, component (J) may be a polydialkylsiloxane fluid (e.g., polydimethylsiloxane) having a viscosity ranging from 0.5 cSt to 10 cSt, alternatively 1 cSt to 5 cSt. Suitable polydimethylsiloxane fluids for use as the vehicle are known in the art and are commercially available under the tradenames DOWSIL™ 200 Fluids and OS Fluids from Dow Silicones Corporation of Midland, Mich., USA. The amount of vehicle depends on various factors including the type and amount of organopolysiloxanes for component (A) and the filler for component (D), however, the amount vehicle may range from 0.0001 wt % to 3 wt %, alternatively 0.0001 wt % to 1 wt %, based on the combined weights of all ingredients in the thermally conductive silicone composition.

(K) Wetting Agent. Additional component (K) is a wetting agent, or a surfactant. Suitable wetting agents include the anionic, cationic, and nonionic surfactants known in the art to act as wetting agents. Suitable surfactants include silicone polyethers, ethylene oxide polymers, propylene oxide polymers, copolymers of ethylene oxide and propylene oxide, other non-ionic surfactants, and combinations thereof. The composition may comprise up to 0.05 wt % of the surfactant based on the weight of the composition. Anionic wetting agents are exemplified by TERGITOL™ No. 7, cationic wetting agents are exemplified by TRITON™ X-100, and nonionic wetting agents are exemplified by TERGITOL™ NR 27, all available from The Dow Chemical Company, Midland, Mich.

### Method of Making the Thermally Conductive Composition

The thermally conductive composition described above may be made by mixing all ingredients, preferably at ambient (20-25° C.) or higher temperature, using any convenient mixing equipment, such as a centrifugal mixer (commercially available from Hauschild) or a Baker-Perkins mixer.

### Uses for the Thermally Conductive Composition

The thermally conductive composition described above may be used as a thermal interface material (TIM). The thermally conductive silicone composition may be interposed along a thermal path between a heat source and a heat dissipator. The thermally conductive silicone composition can be interposed by applying to the heat source (e.g., (opto)electronic component) and the heat dissipator in any order or simultaneously. The thermally conductive silicone composition may be interposed by any convenient means, such as wet-dispensing, screen printing, stencil printing, or solvent casting the thermally conductive silicone composition.

A device according to this invention comprises a) a heat source, b) a thermally conductive silicone composition described above, and c) a heat dissipator, where the thermally conductive silicone composition is positioned between the heat source and the heat dissipator along a thermal path extending from a surface of the heat source to a surface of the heat dissipator.

In the methods and devices described herein, the heat source may comprise an (opto)electronic component such as a light emitting diode (LED), a semiconductor, a transistor, an integrated circuit (IC), or a discrete device. The heat dissipator may comprise a heat sink, a thermally conductive plate, a thermally conductive cover, a fan, a circulating coolant system, or a combination thereof.

The thermally conductive silicone composition may be used in direct contact with the heat source (TIM1). For example, the thermally conductive silicone composition may be applied to the (opto)electronic component and a heat spreader in any order or simultaneously. Alternatively, the thermally conductive silicone composition may be used in direct contact with a first heat dissipator and a second heat dissipator (TIM2). The thermally conductive silicone composition may be applied either to a first heat spreader (such as a metal cover) and thereafter a second heat spreader (such as a heat sink), or the thermally conductive silicone composition may be applied to a second heat spreader and thereafter to a first heat spreader.

### EXAMPLES

These examples are intended to illustrate the invention to one skilled in the art and are not necessarily meant to limit the scope of the invention set forth in the claims. Samples of thermally conductive silicone composition are prepared using the following ingredients. Components used are listed in the below Table 1. Component (A) is exemplified by (a-1). Component (B) is exemplified by (b-1), (b-2), and (b-3). Component (C) is exemplified by (c-1). Component (D-1) is exemplified by (d1-1) and (d1-2). Component (D-2) is exemplified by (d2-1) and (d2-2). Component (D-3) is exemplified by (d3-1) and (d3-2).

TABLE 1

| | Component |
|---|---|
| a-1 | Trimethylsiloxy-terminated poly(dimethylsiloxane/ |
| | methylphenylsiloxane) copolymer, 100 cSt viscosity |
| b-1 | 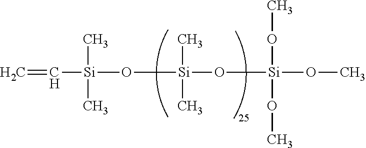 |
| | Dimethyl siloxane, |
| | Mono-trimethoxysiloxy- and |
| | Mono-dimethylvinylsiloxy-terminated, viscosity, (DP = 25) |
| b-2 | Dimethyl siloxane, Mono-trimethoxysiloxy- and |
| | Trimethylsiloxy-terminated, viscosity 130 cP (DP = 110) |
| b-3 | n-Decyltrimethoxysilane |
| c-1 | 29H,31H-phthalocyaninato(2-)-N29,N30,N31,N32 Copper |
| d1-1 | 0.2 μm zinc oxide (ZnO) |
| d2-1 | 2 μm spherical aluminum oxide (Al₂O₃) |
| d2-2 | 11 μm irregular AlN |
| d3-1 | 27 μm spherical aluminum oxide (Al₂O₃) |
| d3-2 | 22 μm irregular AlN |
| d3-3 | 55 μm spherical aluminum oxide (Al₂O₃) |
| d3-4 | 79 μm spherical aluminum oxide (Al₂O₃) |
| d3-5 | 70 μm spherical aluminum nitride (s-AlN) |
| d3-6 | 129 μm near spherical MgO (s-MgO) |
| d3-7 | Vendor pre-blended filler, comprising 129 μm MgO, |
| | 5 μm s-Al₂O₃ and 1 μm s-Al₂O₃ |

Particle size for d1-1 was determined by scanning electron microscopy. For all other particles, the particle size was determined by laser diffraction method using Beckman-Coulter counter LS.

Silicone composition preparation The amount of components used in the examples are listed in Table 2. Components to prepare the inventive silicone composition were mixed in SpeedMixer™ DAC 400.1 FVZ from Flack Tek Inc. Thermal stabilizer (c-1) (copper phthalocyanine CuPc), silicone matrix component (a-1) and appropriate surface treating agent (b-1, b-2, or b-3)) were weighed into a cup of the SpeedMixer. Then small size filler (0.2 μm) (d1-1) and middle size filler (2 μm) (d2-1) were weighed and added into the cup. This mixture was mixed by the SpeedMixer (1000 rpm for 20 seconds, then 1500 rpm for 20 seconds). After mixing, large size filler (>10 μm) (d3-1, d3-2 etc.) was weighed, added and then mixed by the SpeedMixer under the same mixing condition. The resulting paste was scraped into the cup and the above cycle was repeated two more times under the same mixing condition. Samples were placed at room temperature overnight before testing.

Characterization—Thermal conductivity (TC) was measured by Hot Disk transient technology sensor C5501 (Hot Disk AB, Goteborg, Sweden), heat time and power of 2-5 s/500 mW. Each siloxane composition was filled into two cups and a planar sensor was placed inside the cups. Fine-tuned analysis was used, with temperature drift compensation and time correction selected between points 50-150 and 50-190 of the instrument.

Extrusion rate (ER) was measured by Nordson EFD dispensing equipment (Nordson Corporation, Westlake, Ohio, USA). Sample material was packaged into a 30 cc syringe and dispensed at the pressure of 0.62 MPa. The weight of the sample dispensed at lmin was used as the extrusion rate.

Table 2 lists the thermal conductive silicone composition formulations of inventive examples (Inv) and comparative examples (Comp) shown in volume ratios, where the total filler volume was kept constant among all samples.

TABLE 2

| Compo- | | | | | | | |
|---|---|---|---|---|---|---|---|
| nent | | Inv-1 | Comp-1 | Comp-2 | Comp-3 | Comp-4 | Comp-5 |
| (A) | a-1 | 2.78 | 2.78 | 2.78 | 2.78 | 2.78 | 2.78 |
| (B) | b-1 | 1.7 | 1.7 | 1.7 | 1.7 | 1.7 | 1.7 |
| | b-3 | 0.14 | 0.14 | 0.14 | 0.14 | 0.14 | 0.14 |
| (C) | c-1 | 0.02 | 0.02 | 0.02 | 0.02 | 0.02 | 0.02 |
| (D-1) | d1-1 | 20.13 | 20.13 | 20.13 | 20.13 | 20.13 | 0 |
| (D-2) | d2-1 | 32.7 | 0 | 0 | 0 | 0 | 0 |
| | d2-2 | 0 | 0 | 0 | 32.7 | 0 | 0 |
| (D-3) | d3-1 | 0 | 0 | 32.7 | 0 | 0 | 0 |
| | d3-2 | 0 | 0 | 0 | 0 | 27.6 | 0 |
| | d3-3 | 0 | 0 | 27.7 | 0 | 0 | 0 |
| | d3-6 | 40.8 | 40.8 | 40.8 | 40.8 | 40.8 | 0 |
| | d3-7 | 0 | 0 | 0 | 0 | 0 | 83.9 |

| | | | | | | |
|---|---|---|---|---|---|---|
| Total (D) wt % | 95.3 | 95.3 | 95.3 | 95.0 | 94.9 | |
| Total (D) vol % | 83.5 | 83.5 | 83.5 | 83.5 | 83.5 | |
| TC (W/m · K) | 7.80 | NM | NM | NM | NM | NM |
| 50-150 (calc) | | | | | | |
| TC (W/m · K) | 8.36 | NM | NM | NM | NM | NM |
| 50-190 (calc) | | | | | | |
| Flow rate (g/min) | 17.2 | NM | NM | NM | NM | NM |

(unit in volume ratio)
NM = not measurable

All examples contained 0.2 μm zinc oxide (d1-1) as (D-1) filler and 129 μm MgO (d3-6) as (D-3) filler. In Comparative Example 5, these were provided as a pre-mix (d3-7). Inventive Example 1 contained 2 μm spherical Al₂O₃ (d2-1) as (D-2). Comparative Example 3 contained 11 μm AlN (d2-2) as (D-2), and all other Comparative Examples contained no (D-2) but contained an additional (D-3) component. None of the comparative examples could be formulated into a grease form; they became all powdery and did not have a usable consistency. Practical Example 1 showed an excellent thermal performance as well as acceptable flow rate.

Next, in an attempt to increase the thermal conductivity, the amount of MgO was increased, as shown in Table 3.

TABLE 3

| Component | | Inv-2 | Inv-3 | Inv-4 | Inv-5 | Inv-6 | Inv-7 | Comp-6 | Comp-7 |
|---|---|---|---|---|---|---|---|---|---|
| (A) | a-1 | 2.78 | 3.10 | 2.78 | 2.78 | 2.78 | 2.78 | 2.78 | 2.78 |
| (B) | b-1 | 1.7 | 1.7 | 1.7 | 1.7 | 1.7 | 1.7 | 1.7 | 1.7 |
| | b-3 | 0.14 | 0.14 | 0.14 | 0.14 | 0.14 | 0.14 | 0.14 | 0.14 |
| (C) | c-1 | 0.02 | 0.02 | 0.02 | 0.02 | 0.02 | 0.02 | 0.02 | 0.02 |
| (D-1) | d1-1 | 10.7 | 10.7 | 20.13 | 20.13 | 20.13 | 20.13 | 12.9 | 0 |
| (D-2) | d2-1 | 34.6 | 34.6 | 37.2 | 32.7 | 32.7 | 32.7 | 28.7 | 0 |
| (D-3) | d3-5 | 0 | 0 | 0 | 10.0 | 16.3 | 24.0 | 0 | 0 |
| | d3-6 | 44.8 | 44.8 | 40.8 | 32.0 | 24.0 | 16.0 | 49.7 | 49.7 |

| | | | | | | | | |
|---|---|---|---|---|---|---|---|---|
| Total (D) wt % | 95.1 | 94.8 | 95.5 | 95.4 | 95.3 | 95.2 | 95.2 | 91.5 |
| Total (D) vol % | 83.5 | 82.5 | 84.1 | 83.7 | 83.5 | 83.5 | 83.6 | 75.5 |
| TC (W/m · K) 50-150 | 8.07 | 7.74 | 7.80 | 7.82 | 7.56 | 7.85 | NM | NM |
| (calc) | | | | | | | | |
| TC (W/m · K) 50-190 | 8.27 | 7.46 | 8.36 | 7.81 | 7.86 | 7.61 | NM | NM |
| (calc) | | | | | | | | |
| Flow rate (g/min) | 20.1 | 49.9 | 17.20 | 33.40 | 42.80 | 57.00 | NM | NM |

(unit in volume ratio)
NM = not measurable

In Comparative Example 6 and 7, where MgO comprised 60 vol % of the total filler volume, the texture of the composition became powdery as opposed to grease-form. In particular, Comparative Example 7 where only MgO was used, even though the filler volume was lower than others (75.46% vs. 83%), the mixture became powder and could not be further processed. Lowering the MgO volume ratio (Inventive Example 2 and 4) or through adding more oil (Inventive Example 3), thus lowering the total filler volume fraction, prevented the composition from becoming too powdery. Furthermore, Inventive Examples 5, 6 and 7 combined MgO and AlN as larger fillers, which demonstrated improved flow rate while maintaining their high TC property.

Two key properties, thermal conductivity and flow rate of the material, are generally contradictive. However, by optimizing the component ratios, inventors identified a MgO containing composition where both the thermal conductivity and flow rate are superior to conventional Al₂O₃ composition. Table 4 shows Comparative Example 8, which is aluminum based, and Inventive Example 8, which is magnesium based.

TABLE 4

| Component | | Inv-8 | Inv-9 | Comp-8 | Comp-9 |
|---|---|---|---|---|---|
| (A) | a-1 | 3.60 | 2.78 | 2.78 | 2.78 |
| (B) | b-1 | 1.7 | 1.70 | 1.7 | 1.70 |
| | b-3 | 0.14 | 0.14 | 0.14 | 0.14 |
| (C) | c-1 | 0.02 | 0.02 | 0.02 | 0.02 |
| (D-1) | d1-1 | 10.7 | 10.7 | 12.9 | 20.1 |
| (D-2) | d2-1 | 34.6 | 34.6 | 27.5 | 32.7 |
| (D-3) | d3-4 | 0 | 0 | 57 | 8.50 |
| | d3-6 | 44.8 | 44.8 | | 32.0 |

| | | | | |
|---|---|---|---|---|
| Total (D) wt % | 90.2 | 95.1 | 97.4 | 95.3 |
| Total (D) vol % | 81.4 | 83.5 | 83.5 | 83.2 |
| TC (W/m · K) 50-150 (calc) | 6.9 | 8.11 | 6.5 | 7.05 |
| TC (W/m · K) 50-190 (calc) | 7.1 | 8.15 | 6.6 | 7.04 |
| Flow rate (g/min) | 83.4 | 28.4 | 72 | 35.4 |

(unit in volume ratio)

### INDUSTRIAL APPLICABILITY

The thermally conductive composition described above is suitable for use as a thermal interface material in various electronic devices to transfer heat from a heat-generating or heat-bearing part to a heat sink or heat-dissipating part of a device. The thermally conductive composition provides a higher level of thermal conductivity, above 6 W/m·K, previously not available for such use, improving the efficiency and effectiveness of heat transfer while at the same time providing practical handleability.

What is claimed is:

1. A composition comprising:
(A) An organopolysiloxane composition;
(B) a filler treating agent;
(C) a thermal stabilizer; and
(D) thermally conductive filler, comprising:
(D-1) 10 to 20 volume-percent of 0.1 to less than one micrometer zinc oxide particles;
(D-2) 30 to 40 volume-percent of spherical 2 to 6 micrometer sized Al₂O₃ particles;
D-3) 15 to 45 volume-percent of nearly spherical magnesium oxide particles having an average size of 100-150 micrometers; and
wherein the total amount of magnesium oxide particles is in a range of 5 to 55 volume-percent, and where volume-percent values are relative to composition volume.

2. The composition according to claim 1, wherein component (A) comprises:
an organopolysiloxane having a general formula (I)
R¹₃Si—(R¹R²SiO)ₐ(R¹₂SiO)_{b}—R³—SiR¹₃ (I)
wherein each R¹ is independently a C1-C6 alkyl group, each R² is an aryl group, each R³ is selected from an oxygen atom or a divalent hydrocarbon group, subscript a is 0 or has an average value of at least 1, subscript b has an average value of at least 1.

3. The composition of claim 1, wherein component (B) comprises a silicone and/or a silane.

4. The composition according to claim 3, wherein component (B) is selected from the group consisting of alkyl trialkoxysilane and trialkoxysiloxy-terminated dimethylpolysiloxane.

5. The composition according to claim 4, wherein the trialkoxysiloxy-terminated dimethylpolysiloxane is further alkenyl-end-capped.

6. The composition according to claim 5, wherein component (B) is selected from n-decyltrimethoxysilane and dimethylvinylsiloxy- and trimethoxysiloxy-terminated dimethylpolysiloxane.

7. The composition according to claim 1, wherein component (C) is phthalocyanine with or without a metal associated with it.

8. The composition of claim 1, further comprising an additional ingredient selected from (G) a spacer, (H) an antioxidant stabilizer, (I) a pigment, (J) a vehicle, or (K) a wetting agent, and a combination thereof.

9. A method comprising interposing the composition of claim 1, along a thermal path between a heat source and a heat dissipator.

10. The method of claim 9, where the heat source comprises an (opto)electronic component.

11. A device comprising:
a) a heat source,
b) a composition according to claim 1, and
c) a heat dissipator;
where the composition is positioned between the heat source and the heat dissipator along a thermal path extending from a surface of the heat source to a surface of the heat dissipator.
